(19) United States
(12) Patent Application Publication
(10) Pub. No.: US 2024/0253205 A1
(43) Pub. Date: Aug. 1, 2024

(54) MULTIFUNCTIONAL WORKBENCH

(71) Applicant: NINGBO VERTAK MECHANICAL & ELECTRONIC CO., LTD, Ningbo (CN)

(72) Inventor: Yiqiao Fu, Ningbo (CN)

(21) Appl. No.: 18/629,499

(22) Filed: Apr. 8, 2024

(30) Foreign Application Priority Data
Mar. 4, 2024 (CN) 202420415782.4

(51) Int. Cl. B25H 1/04; B25H 1/14

(52) U.S. Cl. CPC B25H 1/04; B25H 1/14

(57) ABSTRACT

The present invention relates to a multifunctional workbench. The multifunctional workbench includes a main body part and at least one mounting part. The mounting part is detachably arranged on the main body part. When the mounting part is mounted on the main body part, the main body part forms a complete workbench surface, so that the defect that a workbench on the current market cannot be used as a complete workbench table is overcome.

### TECHNICAL FIELD

The present invention relates to the field, and in particular, to a multifunctional workbench.

### BACKGROUND

A woodworking workbench is a special table for a woodworker, and is characterized by including a flat and firm working surface and one or more methods for fixing a material that is being treated. The woodworking workbench has a variety of styles, depending on a working type thereof or a working mode that a user likes.

There are numerous workbenches with many types and many functions on the market at present, such as a workbench for clamping parts and articles and a workbench for a machine equipment platform. Most of existing woodworking workbenches are fixed or semi-fixed. Although the workbenches are stable in use, the space utilization, mobility and multifunctionality are limited. Especially when the workbench is required to be used as a complete workbench, the traditional workbench often cannot meet the requirement due to the lack of necessary structural design to achieve this function. Therefore, a workbench is required to overcome the defect that the workbench in the current market cannot be used as a complete workbench table.

### SUMMARY

An advantage of the present invention is to provide a multifunctional workbench. According to the multifunctional workbench, a mounting part is mounted and a complete workbench surface is formed, so that the defect that the workbench on the current market cannot be used as a complete workbench table is overcome.

Another advantage of the present invention is to provide a multifunctional workbench. The multifunctional workbench not only can be used as a traditional woodworking workbench, but also can be converted into a complete workbench table, so that the use flexibility of the multifunctional workbench is improved.

Another advantage of the present invention is to provide a multifunctional workbench. According to the multifunctional workbench, through the design of a mounting plate and a control piece, the whole multifunctional workbench can be assembled and disassembled very rapidly and conveniently.

Another advantage of the present invention is to provide a multifunctional workbench. The multifunctional workbench can be used as a foldable workbench after the mounting part is mounted; and the multifunctional workbench can be used as a foldable woodworking workbench after the mounting part is demounted, so that the practicability and diversity of the multifunctional workbench are achieved.

Another advantage of the present invention is to provide a multifunctional workbench. The multifunctional workbench solves the limitation of workbenches in the market, and a novel workbench with a simple structure and multiple functions and easy to operate is provided.

Another advantage of the present invention is to provide a multifunctional workbench. The multifunctional workbench is simple in structural design, low in manufacturing cost and convenient to popularize and apply.

According to another aspect of the present invention, the present invention further provides a multifunctional workbench. The multifunctional workbench includes:
a main body part; and
at least one mounting part, where the mounting part is detachably arranged on the main body part, and the main body part forms a complete workbench surface when the mounting part is mounted on the main body part.

According to one embodiment of the present invention, the mounting part includes a mounting plate, a first mounting piece and a second mounting piece; the first mounting piece and the second mounting piece are respectively located at two ends of the mounting plate; and the mounting plate is fixed on the main body part through the first mounting piece and the second mounting piece.

According to one embodiment of the present invention, the mounting part further includes a control piece; the control piece is arranged on the mounting plate; and the control piece is suitable for controlling a distance of the first mounting piece extending out of a front end of the mounting plate.

According to one embodiment of the present invention, the control piece includes a pushing module and a limiting module; the first mounting piece is arranged between the pushing module and the limiting module; and the pushing module is suitable for controlling the first mounting piece to slide forwards or backwards.

According to one embodiment of the present invention, the first mounting piece has a groove; the groove concavely extends downwards from a surface of the first mounting piece; the pushing module includes a protrusion; the protrusion convexly extends from a surface of the pushing module; and the protrusion of the pushing module is clamped in the groove of the first mounting piece.

According to one embodiment of the present invention, the workbench surface has a first mounting area and a second mounting area; and the mounting part is detachably mounted at the second mounting area.

According to one embodiment of the present invention, the main body part further includes a fixed plate and a movable plate; the fixed plate is fixed at the first mounting area; and the movable plate is suitable for sliding from an interior of the first mounting area.

According to one embodiment of the present invention, the main body part further includes a workbench surface frame; the first mounting area and the second mounting area are located in the workbench surface frame; the workbench surface frame has a first mounting hole and a second mounting hole; and the first mounting hole and the second mounting hole are respectively formed in front and rear sides of the workbench surface frame to match the first mounting piece and the second mounting piece.

According to one embodiment of the present invention, the main body part further includes a moving piece and a supporting part; the moving piece is mounted on the workbench surface frame; the fixed plate is fixed to the moving piece; the movable plate is suitable for sliding from the interior of the first mounting area through the moving piece; and the supporting part is connected below the workbench surface frame.

According to one embodiment of the present invention, the number of the mounting parts is set to two; and the second mounting area is located on two sides of the first mounting area for the two mounting parts to be mounted, respectively.

Further objectives and advantages of the present invention will be fully embodied through the following description and accompanying drawings.

### BRIEF DESCRIPTION OF THE DRAWINGS

FIG. 1 is a schematic diagram of an overall structure of a multifunctional workbench according to a first preferred embodiment of the present invention;

FIG. 2 is a first schematic exploded view of a multifunctional workbench according to a first preferred embodiment of the present invention;

FIG. 3 is a second schematic exploded view of a multifunctional workbench according to a first preferred embodiment of the present invention; and

FIG. 4 is a sectional view of a mounting part of a multifunctional workbench according to a first preferred embodiment of the present invention.

### DESCRIPTION OF THE EMBODIMENTS

The following description is used to disclose the present invention to enable those skilled in the art to implement the present invention. The preferred embodiments in the following description are only examples, and other apparent variations will occur to those skilled in the art. The basic principle of the present invention defined in the following description may be applied to other embodiments, variations, improvements, equivalents and other technical solutions without departing from the spirit and scope of the present invention.

It should be understood by those skilled in the art that in the disclosure of the present invention, orientation or position relationships indicated by terms “longitudinal”, “transverse”, “upper”, “lower”, “front”, “rear”, “left”, “right”, “vertical”, “horizontal”, “top”, “bottom”, “inside”, “outside” and the like are orientation or position relationships shown in the drawings, and these terms are merely for facilitating the description of the present invention and simplifying the description, but not for indicating or implying that the mentioned device or elements must have a specific orientation and must be established and operated in a specific orientation, and thus, these terms cannot be understood as a limitation to the present invention.

It may be understood that the term “one” should be understood as “at least one” or “one or more”, that is, in one embodiment, the number of one element may be one, while in other embodiments, the number of elements may be multiple, the term “one” cannot be understood as a limitation to the number.

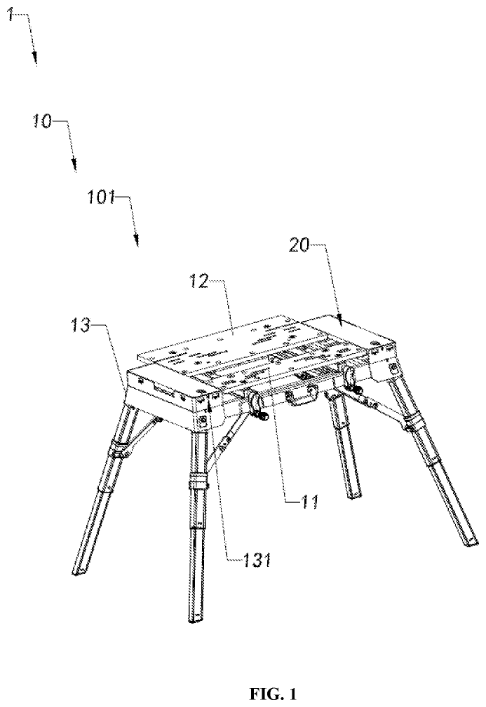

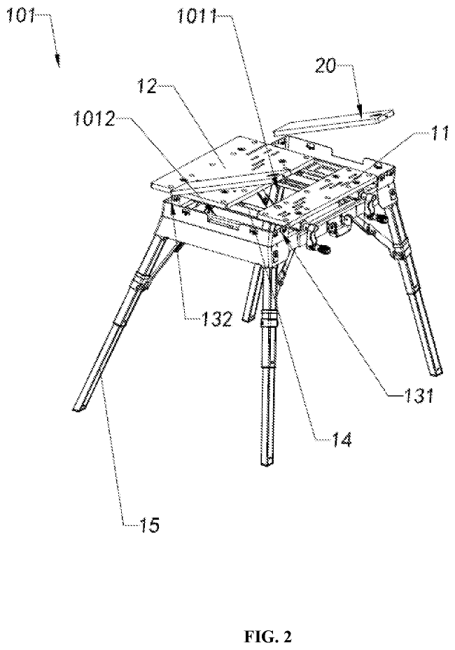

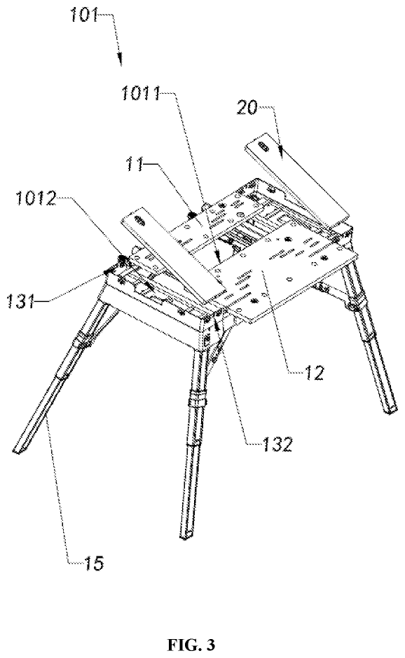

Referring to FIG. 1 to FIG. 4, they are illustrated according to a multifunctional workbench according to a preferred embodiment of the present invention. The multifunctional workbench 1 not only can be used as a traditional woodworking workbench, but also can be converted into a complete workbench table, so that the use flexibility of the multifunctional workbench is improved.

FIG. 1 is a schematic diagram of an overall structure of a multifunctional workbench 1 according to a first preferred embodiment of the present invention. In this embodiment, the multifunctional workbench 1 includes a main body part 10 and at least one mounting part 20, and the mounting part is detachably mounted on the main body part 10. In the embodiment of the present application, the number of the mounting parts 20 is set to two, and the mounting parts 20 are suitable for being mounted on two sides of the main body part 10.

Specifically, after the mounting part 20 is mounted on the main body part 10, the multifunctional workbench 1 may be used as a foldable workbench; and after the mounting part 20 is demounted from the main body part 10, the multifunctional workbench 1 may be used as a foldable woodworking workbench, so that the practicability and diversity of the multifunctional workbench 1 are achieved.

For ease of illustration, it is defined that the main body part 10 has a workbench surface 101, the workbench surface 101 has a first mounting area 1011 and a second mounting area 1012. In the embodiment of the present application, the second mounting area 1012 is located on two sides of the first mounting area 1011, the mounting part 20 is suitable for being mounted at the second mounting area 1012, and the main body part 10 forms a complete workbench surface 101 after the mounting part 20 is mounted at the second mounting area 1012.

The main body part 10 further includes a fixed plate 11 and a movable plate 12, the fixed plate 11 and the movable plate 12 are mounted at the first mounting area 1011, the fixed plate 11 is fixed at the first mounting area 1011, and the movable plate 12 is suitable for sliding from an interior of the first mounting area 1011 to change the own position, thereby meeting different woodworking requirements.

The main body part 10 further includes a workbench surface frame 13 and a moving piece 14, the moving piece 14 is mounted on the workbench surface frame 13, and the workbench surface frame 13 surrounds the first mounting area 1011 and the second mounting area 1012, that is, the first mounting area 1011 and the second mounting area 1012 are located in the workbench surface frame 13. The fixed plate 11 is fixed on the moving piece 14, and the movable plate 12 is suitable for sliding from the interior of the first mounting area 1011 through the moving piece 14. Preferably, the moving piece 14 is set to a sliding rail.

The main body part 10 further includes a supporting part 15, the supporting part 15 is connected to the workbench surface frame 13, and the supporting part 15 includes a plurality of supporting legs for supporting. In addition, a plurality of reinforcing rib structures are arranged between the supporting part 15 and the workbench surface frame 13, so that the multifunctional workbench 1 has higher supporting strength and stability.

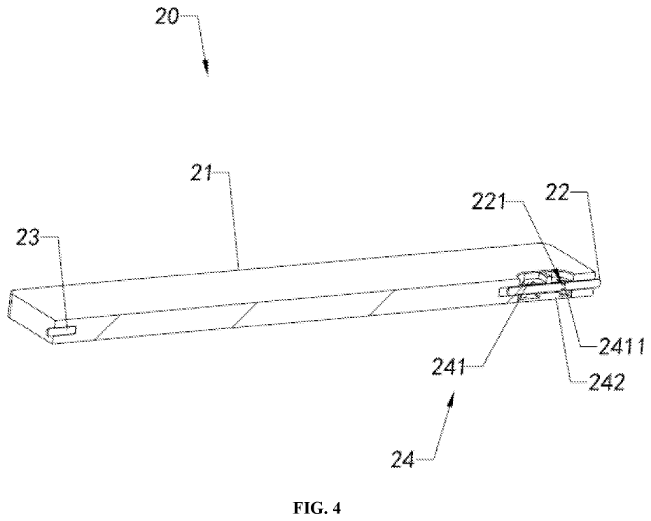

FIG. 4 is a sectional view of a mounting part of a multifunctional workbench according to a first preferred embodiment of the present invention. Specifically, the mounting part 20 includes a mounting plate 21, a first mounting piece 22 and a second mounting piece 23, and the first mounting piece 22 and the second mounting piece 23 are respectively located at two ends of the mounting plate 21. The mounting plate 21 is fixed on the workbench surface frame 13 of the main body part 10 through the first mounting piece 22 and the second mounting piece 23, and is located in the second mounting area 1012, so that the main body part 10 forms a complete workbench surface 101, and the multifunctional workbench 1 can be used as a foldable workbench.

Specifically, the workbench surface frame 13 has a first mounting hole 131 and a second mounting hole 132, the first mounting hole 131 and the second mounting hole 132 are respectively arranged on front and rear sides of the workbench surface frame 13, that is, the first mounting hole 131 extends backwards from a front part of the workbench surface frame 13 to penetrate through the workbench surface frame 13, and the second mounting hole 132 extends forwards from a rear part of the workbench surface frame 13 to penetrate through the workbench surface frame 13.

More specifically, the first mounting piece 22 of the mounting part 20 corresponds to the first mounting hole 131 of the workbench surface frame 13, and the second mounting piece 23 of the mounting part 20 corresponds to the second mounting hole 132 of the workbench surface frame 13. When the mounting part 20 is mounted on the main body part 10, the first mounting piece 22 is inserted into the first mounting hole 131, and the second mounting piece 23 is inserted into the second mounting piece 132, so that the mounting plate 21 is fixed on the workbench surface frame 13.

It is worth mentioning that, in the embodiment of the present application, the number of the mounting parts 20 is set to two, and the mounting parts 20 are suitable for being mounted on two sides of the main body part 10. Based on this, both sides of the workbench surface frame 13 have the first mounting hole 131 and the second mounting hole 132, thereby respectively corresponding to the first mounting piece 22 and the second mounting piece 23 of the two mounting parts 20.

It is further worth mentioning that, in the embodiment of the present application, the first mounting piece 22 and the second mounting piece 23 are preferably and actually pins so as to be conveniently placed in the first mounting hole 131 and the second mounting hole 132 for fixation.

The mounting part 20 further includes a control piece 24; the control piece 24 is arranged on the mounting plate 21; and the control piece 24 is configured to control a distance of the first mounting piece 22 extending out of a front end of the mounting plate 21. Specifically, when the control piece 24 slides forwards, the distance of the first mounting piece 22 extending out of the front end of the mounting plate 21 is increased; and when the control piece 24 slides backwards, the distance of the first mounting piece 22 extending out of the front end of the mounting plate 21 is reduced.

The control piece 24 includes a pushing module 241 and a limiting module 242, the first mounting piece 22 is arranged between the pushing module 241 and the limiting module 242, and the pushing module 241 is suitable for controlling the first mounting piece 22 to slide forwards or backwards. Specifically, the first mounting piece 22 has a groove 221, the groove 221 concavely extends downwards from a surface of the first mounting piece 22, the pushing module 241 includes a protrusion 2411, the protrusion 2411 convexly extends from a surface of the pushing module 241, and the protrusion 2411 of the pushing module 241 is clamped in the groove 221 of the first mounting piece 22, so that the pushing module 241 is suitable for driving the first mounting piece 22 to slide forwards or backwards.

In addition, an elastic element, such as a spring, may be arranged on one side of the pushing module 241 and the limiting module 242. After the pushing module 241 and the limiting module 242 slide forwards or backwards, the pushing module 241 and the limiting module 242 can be restored to the original positions by loosening hands.

In the embodiment of the present application, the control piece 24 and the first mounting piece 22 are subjected to connection control in a clamping manner. In other embodiments, the control piece 24 and the first mounting piece 22 can be subjected to connection control in other manners, which is not limited in the present invention.

A method of mounting the main body part 10 on and demounting the main body part 10 from the mounting part 20 is exemplarily described as follows: when the mounting part 20 is mounted, the second mounting piece 23 is firstly placed in the second mounting hole 132, and then the control piece 24 is pushed, so that the distance of the first mounting piece 22 extending out of the front end of the mounting plate 21 is reduced; the mounting plate 21 is pressed in the second mounting area 1012 of the workbench surface 101; finally, the control piece 24 is controlled, so that the distance of the first mounting piece 22 extending out of the front end of the mounting plate 21 is increased; and the first mounting piece 22 is placed in the first mounting hole 131 to complete the mounting of the mounting part 20.

When the mounting part 20 is demounted, the control piece 24 is pushed, so that the distance of the first mounting piece 22 extending out of the front end of the mounting plate 21 is reduced; the front end of the mounting plate 21 is taken out of the second mounting area 1012 of the workbench surface 101; and then the second mounting piece 23 is taken out of the second mounting hole 132 to complete the demounting of the mounting part 20. According to the multifunctional workbench 1, through the design of the mounting plate 21 and the control piece 24, so that the whole multifunctional workbench 1 can be assembled and disassembled very rapidly and conveniently.

In conclusion, according to the multifunctional workbench 1, a complete workbench surface 101 is formed by mounting the mounting part 20, so that the defect that the workbench in the current market cannot be used as a complete workbench table is overcome. The multifunctional workbench 1 can be used as a foldable workbench after the mounting part 20 is mounted; and the multifunctional workbench can be used as a foldable woodworking workbench after the mounting part 20 is demounted, so that the practicability and diversity of the multifunctional workbench 1 are achieved. Based on this, the multifunctional workbench not only can be used as a traditional woodworking workbench, but also can be converted into a complete workbench table, so that the use flexibility of the multifunctional workbench is improved.

It should be understood by those skilled in the art that the embodiments of the invention described above and shown in the accompanying drawings are illustrative only and do not limit the present invention. The objectives of the present invention have been completely and effectively achieved. The functional and structural principles of the present invention have been shown and described in the embodiments, and any variations or modifications may be made to the embodiments of the present invention without departing from the principles.

What is claimed is:

1. A multifunctional workbench comprising:
a main body part; and
at least one mounting part, wherein the mounting part is detachably arranged on the main body part, and the main body part forms a complete workbench surface when the mounting part is mounted on the main body part.

2. The multifunctional workbench according to claim 1, wherein the mounting part comprises a mounting plate, a first mounting piece and a second mounting piece; the first mounting piece and the second mounting piece are respectively located at two ends of the mounting plate; and the mounting plate is fixed on the main body part through the first mounting piece and the second mounting piece.

3. The multifunctional workbench according to claim 2, wherein the mounting part further comprises a control piece; the control piece is arranged on the mounting plate; and the control piece is suitable for controlling a distance of the first mounting piece extending out of a front end of the mounting plate.

4. The multifunctional workbench according to claim 3, wherein the control piece comprises a pushing module and a limiting module; the first mounting piece is arranged between the pushing module and the limiting module; and the pushing module is suitable for controlling the first mounting piece to slide forwards or backwards.

5. The multifunctional workbench according to claim 4, wherein the first mounting piece has a groove; the groove concavely extends downwards from a surface of the first mounting piece; the pushing module comprises a protrusion; the protrusion convexly extends from a surface of the pushing module; and the protrusion of the pushing module is clamped in the groove of the first mounting piece.

6. The multifunctional workbench according to claim 5, wherein the workbench surface has a first mounting area and a second mounting area; and the mounting part is detachably mounted at the second mounting area.

7. The multifunctional workbench according to claim 6, wherein the main body part further comprises a fixed plate and a movable plate; the fixed plate is fixed at the first mounting area; and the movable plate is suitable for sliding from an interior of the first mounting area.

8. The multifunctional workbench according to claim 7, wherein the main body part further comprises a workbench surface frame; the first mounting area and the second mounting area are located in the workbench surface frame; the workbench surface frame has a first mounting hole and a second mounting hole; and the first mounting hole and the second mounting hole are respectively formed in front and rear sides of the workbench surface frame to match the first mounting piece and the second mounting piece.

9. The multifunctional workbench according to claim 8, wherein the main body part further comprises a moving piece and a supporting part; the moving piece is mounted on the workbench surface frame; the fixed plate is fixed to the moving piece; the movable plate is suitable for sliding from the interior of the first mounting area through the moving piece; and the supporting part is connected below the workbench surface frame.

10. The multifunctional workbench according to claim 9, wherein the number of the mounting parts is set to two; and the second mounting area is located on two sides of the first mounting area for the two mounting parts to be mounted, respectively.
